(19) United States
(12) Patent Application Publication
(10) Pub. No.: US 2025/0380092 A1
(43) Pub. Date: Dec. 11, 2025

(54) METHOD FOR OPERATING A HEARING DEVICE

(71) Applicant: Sivantos Pte. Ltd., Singapore (SG)

(72) Inventors: Jurek FOELLMER, Erlangen (DE); Cecil WILSON, Erlangen (DE)

(73) Assignee: Sivantos Pte. Ltd., Singapore (SG)

(21) Appl. No.: 19/231,402

(22) Filed: Jun. 6, 2025

(30) Foreign Application Priority Data
Jun. 7, 2024 (DE) 10 2024 205 257.4

(51) Int. Cl. H04R 25/00

(52) U.S. Cl. CPC H04R 25/505; H04R 25/43; H04R 2225/41; H04R 2225/43

(57) ABSTRACT

A method for operating a hearing device, in which an input signal is generated based on an ambient sound. A first signal component and a second signal component are extracted from the input signal. The first signal component corresponds to speech of a user, and the second signal component corresponds to speech of another person. A first processed signal is generated based on the first signal component and a first amplification factor, and a second processed signal is generated based on the second signal component and a second amplification factor. The two processed signals are combined to form an output signal. The second amplification factor is selected as a function of a difference between a level of the first processed signal and a level of the second processed signal. A hearing device is also provided.

This nonprovisional application claims priority under 35 U.S.C. § 119(a) to German Patent Application No. 10 2024 205 257.4, which was filed in Germany on Jun. 7, 2024, and which is herein incorporated by reference.

### BACKGROUND OF THE INVENTION

### Field of the Invention

The invention relates to a method for operating a hearing device, and to a hearing device. The hearing device comprises a microphone for detecting ambient sound, and a signal processing unit.

### Description of the Background Art

Persons with reduced hearing generally use a hearing aid, in which ambient sound is detected using an electromechanical acoustic transducer. The electrical signals generated based on the ambient sound are amplified using an amplifier circuit, and introduced into the auditory canal of the person by means of a further electromechanical transducer in the form of an earphone. In addition, the detected sound signals are usually processed, customarily using a signal processor of the amplifier circuit. The amplification is coordinated with any hearing loss of the wearer of the hearing aid, also referred to below as a user. When the user him/herself speaks, this is likewise detected by means of the electromechanical acoustic transducer, amplified corresponding to the selected amplification, and introduced into the auditory canal.

In order for the sounds of interest to the user to be audible both in loud and soft environments, but without excessive and therefore unpleasant amplification taking place, it is known to use an automatic gain control. The sounds present in the surroundings at the time are amplified, according to their respective circumstances, in such a way that they have a level between a predefined minimum and a predefined maximum. In other words, the amplification is adapted to the present surroundings, with loud sounds being perceivable to the user as loud sounds, and soft sounds being perceivable as soft sounds.

However, it is possible that the user may have only comparatively poor perception of his/her voice or the voice of a conversation partner due to existing background noise. The natural response by the user is to speak more loudly, so that the conversation partner is likewise motivated to speak more loudly. This phenomenon is known as the “Lombard effect.” However, when the automatic gain control is active, the louder speaking by the user does not result in the user him/herself perceiving this as being louder. As a result, the user will speak even more loudly, which then causes discomfort for the conversation partner.

### SUMMARY OF THE INVENTION

It is therefore an object of the invention to provide a particularly suitable method for operating a hearing device, and a particularly suitable hearing device, wherein in particular comfort for a user is increased and/or having a conversation is improved.

In an example, the method is used to operate a hearing device. For example, the hearing device can be a headphone or includes a headphone, and the hearing device can be a headset, for example. However, the hearing device can bea hearing aid. The hearing aid is used to assist a person with reduced hearing. In other words, the hearing aid is a medical device by means of which partial hearing loss, for example, is compensated for. The hearing aid is, for example, a “receiver in the canal” (RIC) hearing aid, an ear-internal hearing aid such as an “in the ear” hearing aid, an “in the canal” (ITC) hearing aid, or a “completely in canal” (CIC) hearing aid, hearing aid glasses, or a pocket hearing aid. The hearing aid can be a “behind the ear” hearing aid that is worn behind the outer ear.

The hearing device can be provided and configured to be worn on the human body. In other words, the hearing device can include a mounting apparatus by means of which fastening to the human body is possible. If the hearing device is a hearing aid, the hearing device is provided and configured to be situated, for example, behind the ear or inside an auditory canal. In particular, the hearing device is wireless, and is provided and configured to be at least partially inserted into an auditory canal.

The hearing device can include a microphone that is used to detect sound. In particular, during operation the microphone detects an ambient sound, i.e., sound waves, or at least a portion thereof. The microphone is advantageously situated, at least in part, inside a housing of the hearing device, and is thus at least partially protected. The microphone is suitably an electromechanical acoustic transducer. The microphone has, for example, only a single microphone unit, or multiple microphone units that interact with one another. Each of the microphone units advantageously has a diaphragm that is set into vibration by sound waves, the vibrations being converted into an electrical signal using an appropriate receiver device, such as a magnet, that is moved in a coil. The microphone units can have a capacitive design, and use is made of the fact that a voltage that is present changes when the distance of the diaphragm from a stationary surface of the microphone unit changes. The voltage is present in particular between the diaphragm and the stationary surface. The microphone units can have an omnidirectional design. In this or some other manner, by means of the microphone it is at least possible to generate or at least provide an input signal that is based on the sound, in particular the ambient sound, that impinges on the microphone.

The hearing device can have an earphone for outputting an output signal. The output signal is in particular an electrical signal, and for example has a digital or suitably analog design. The earphone can be an electromechanical acoustic transducer, for example a speaker. Depending on the design of the hearing device, in the state of use as intended the earphone is situated at least partially inside an auditory canal of a user of the hearing device, i.e., a person also referred to as a wearer, or is at least acoustically connected thereto. The hearing device in particular is used primarily to output the output signal by means of the earphone, with generation of a corresponding sound. In other words, the main function of the hearing device can be to output the output signal.

The hearing device can include a signal processing unit by means of which the possibly present microphone and the possibly present earphone are connected via signaling. The hearing device advantageously includes a signal processor which, for example, forms the signal processing unit or is at least an integral component thereof. The signal processor is, for example, a digital signal processor (DSP) or is implemented using analog components. The input signal generated via the microphone is in particular adapted by use of the signal processor or at least the signal processing unit. At the minimum, the signal processing unit is suited, in particular provided and configured, for this purpose. If the signal processor is designed as a digital signal processor, an A/D converter is advantageously situated between the microphone and the signal processing unit, for example the signal processor. The hearing can also include an amplifier, or the amplifier is formed at least in part by the signal processing unit. For example, the amplifier is connected upstream or downstream from the signal processor via signaling.

The method provides that the input signal can be based on the ambient sound. In other words, in particular the ambient sound is detected, on the basis of which the input signal is generated. The input signal is suitably an electrical signal, and generation advantageously takes place by means of the microphone(s). The input signal corresponds, for example, to the unprocessed ambient sound, or for example is already processed. The input signal advantageously has a certain directional characteristic, so that a certain portion of the surroundings, in particular sound from a certain solid angle, may be detected with greater intensity.

A first signal component and a second signal component can be extracted from the input signal. For example, the input signal includes even further components that are associated with neither the first nor the second signal component. The first signal component corresponds to speech of the user, whereas the second signal component corresponds to speech of another person. Thus, the portion of the ambient sound that arises from speech of the user is associated with the first signal component. The portion of the ambient sound that arises from speech of the other person is associated with the second signal component. For the corresponding association, for example a spatial analysis is performed concerning where the ambient sound has originated. The splitting can be carried out using a frequency analysis, for example, or in some other way.

If the two signal components are not present in the input signal in particular at least for a certain time period, such as 5 minutes, 2 minutes, 1 minute, 30 seconds, or 10 seconds, as is the case for a conversation, for example, the method is advantageously terminated. The method is suitably started only when both the first signal component and the second signal component are present in the input signal, and/or when a certain operating mode of the hearing device is selected.

A first processed signal can be generated based on the first signal component and a first amplification factor. For example, the first signal component is amplified by use of the first amplification factor, so that the first processed signal is generated. The first amplification factor is a constant value, for example. The first amplification factor may not be constant, for example, and in particular is a function of a frequency of the particular individual portions of the first signal component. In particular, the first amplification factor relates to amplification, compression, and/or directionality. The first amplification factor can relate to noise suppression. At the minimum, the first signal component is processed by use of the first amplification factor, so that the first processed signal is generated. In other words, the first amplification factor suitably corresponds to a parameter set by means of which the first signal component is processed, so that the first processed signal is generated. Preferably only the processing takes place by use of the first amplification factor, or for example even further processing steps take place in order to generate the first processed signal.

Furthermore, a second processed n be icas generated based on the second signal component and a second amplification factor. The second amplification factor is, for example, only a value that is constant. The second amplification factor can be a function of a frequency of the individual parts of the second signal component. Compression, directionality, and/or setting of noise suppression can be described by the second amplification factor. At the minimum, by use of the second amplification factor the second signal component is processed in such a way that the second processed signal is generated. For example, the second processed signal is generated based only on the processing using the second amplification factor, or even further processing steps take place for this purpose.

In a further work step the two processed signals can be combined to form the output signal. In particular, for this purpose the two processed signals are added or combined in some other way, for example added with weighting. The first signal component, the second signal component, the input signal, and the output signal are in particular electrical signals. The corresponding processing advantageously takes place by means of the possibly present signal processing unit, suitably by means of the digital signal processor. The output signal is advantageously output, for example by means of the possibly present earphone, so that in particular output sound is generated, which is suitably introduced into the auditory canal of the user.

The respective first amplification factor or second amplification factor is always positive or negative, for example, or both may be negative or positive, for example, advantageously as a function of certain requirements. The second amplification factor is selected as a function of a difference between the level of the first processed signal and the level of the second processed signal. The level of the two processed signals is advantageously determined for this purpose.

Based on the method, the sound that originates from the user's own speech is thus changed corresponding to the first amplification factor, and correspondingly perceived. by the user. The sound that originates from the speech of other persons is perceived in adaptation thereto. When the user now converses with the other person, it may be comparatively difficult for the user to understand the other person, for example because of an incorrectly set signal processing unit, further impaired hearing, and/or unfavorable background noise. In this case the user will unconsciously speak more loudly. As a result, the difference between the level of the first processed signal and the level of the second processed signal changes. Consequently, the second amplification factor is adapted so that the level of the second processed signal is subsequently in particular increased. Thus, even if the other person does not speak more loudly, he/she is more easily understandable by the user, as a result of which comfort for the user is increased and having a conversation is improved. It is thus possible to make use of the Lombard effect, which describes that persons in a comparatively loud environment will likewise (unconsciously) speak more loudly, even if the person with whom the user is speaking is not susceptible to this effect.

The second amplification factor can be designed in such a way that a signal-to-noise ratio (SNR) of the two processed signals relative to one another, or at least of the second processed signal, also has a certain ratio or at least is within a certain range. Speech intelligibility is thus further enhanced.

The first amplification factor can be predefined as a function of a possibly present hearing loss of the user. The first amplification factor can be predefined by the user or in particular is adapted to the user. The first amplification factor can be selected as a function of the ambient sound and/or a classification of the surroundings.

The second amplification factor can be selected in such a way that the level of the first processed signal differs from the level of the second processed signal by less than a limit value. For example, a determination of the second amplification factor takes place only at certain points in time, for example at the beginning of the method and/or when a certain operating mode is set, or when the second signal component is present for the first time. A continuous adaptation of the second amplification factor may take place, at least as long as the second signal component can be extracted from the input signal.

The limit value can be, for example, constant or is a function of a present situation of the user. For example, the second amplification factor is selected in such a way that the levels of the two signals are equal. The second amplification factor can be selected in such a way that the two levels only differ precisely by the limit value. At least the level of the second processed signal can be lower than the level of the first processed signal when the level of the second signal component is lower than the level of the first signal component, and vice versa. Thus, there is no excessive shift in the ratios relative to one another.

For example, the first amplification factor, to which a certain value is added as a function of the difference, can be used as the second amplification factor. For this purpose, for example the first processed signal is initially generated and its level is determined. On this basis, the second amplification factor is then selected. For example, a compression curve can be temporally changed, or a time constant is added to an adaptive compression system. For example, the second amplification factor may already be generated, based on the first signal component and the second signal component, in particular their levels relative to one another, and based on knowledge about the first amplification factor, so that for the processed signals that are then generated, the difference is less than the limit value. In particular, only the second amplification factor is changed when the difference is greater than the limit value. In contrast, with an original second amplification factor that is, for example, equal to the first amplification factor, if the difference is less than the limit value, it is advantageous that no change of the second amplification factor takes place.

For example, initially a second preliminary processed signal can be generated, based on the second signal components and a second preliminary amplification factor. The second preliminary amplification factor is in particular correspondingly predefined/designed the same as the first amplification factor, and can be adapted to any hearing loss of the user. The level of the second preliminary processed signal is compared to the level of the first processed signal, and the second amplification factor is selected based on the comparison. Based on the second preliminary processed signal, the second processed signal is generated, using the second amplification factor. Thus, the second signal component is initially processed with the second preliminary amplification factor and then with the second amplification factor, so that the second processed signal is generated. Adapting the level of the second processed signal to the level of the first processed signal is thus facilitated. In particular, the additional adaptation takes place only when the level of the first processed signal differs from the level of the second preliminary processed signal by more than the limit value. If the difference is smaller, “1” or the identity is suitably used as the second amplification factor, so that the second preliminary processed signal corresponds to the second processed signal. In contrast, if the difference is greater than the limit value, a corresponding selection of the second amplification factor suitably takes place, so that in comparison to the second preliminary processed signal the second processed signal is shifted in the direction of the first processed signal. Subsequently, the difference between the levels of the two processed signals is suitably equal to the limit value, so that no excessive shift takes place, and therefore the ratio of the processed signals compared to the two signal components is not excessively changed.

Automatic gain control (AGC) can be used. Multiple amplification curves are suitably used to map the input signal onto the output signal. The particular amplification curve is selected in particular as a function of the present surroundings or the present situation, so that the level of the output signal advantageously varies between predefined limits. Consequently, all sounds of interest to the user are perceivable by him/her, but an excessively loud amplification does not occur. The amplification curves can be linear, at least in sections, and/or are at least continuous, so that relationships of the level of sounds contained in the input signal with respect to one another remain in the output signal, which facilitates understandability for the user.

A first amplification curve for the first signal component and a second amplification curve for the second signal can be advantageously used. In other words, a different amplification curve, and therefore different amplification factors, is/are associated with the different signal components. The two signal components are thus amplified differently, at least in sections, so that the difference between the levels of the two processed signals meets a certain specification that is predefined by the two amplifications. The second amplification factor, which is determined at least in part using the second amplification curve, is thus selected based on the difference between the levels of the processed signals. Due to the use of automatic gain control, comfort for the user is improved in the particular present situation, regardless of whether the user is in a comparatively loud or soft environment. Based on the different amplification curves, use is made of the Lombard effect, so that when the user has the feeling that the other person is hard to understand, and therefore speaks more loudly, the possibly louder speech of the other person is rendered with greater intensity, which enhances understandability.

In particular, background noise is initially determined. The background noise corresponds in particular to the portion of the input signal that is associated neither with the first signal component nor the second signal component. The level of the background noise is determined. The present situation of the levels is thus associated with the background noise. The two amplification curves are designed in such a way, for example, that they are different for the background noise. However, the two amplification curves can be the same for the level associated with the background noise of the present situation. Thus, when neither the speech of the user nor the speech of the other person is present, it is irrelevant whether this portion of the input signal is associated with the first signal component or with the second signal component. The processing always takes place immediately, and thus in particular always results in the same portion in the output signal. Therefore, when there is a pause in the conversation there is a change between the two amplification curves, without resulting in a different characteristic of the output signal. In other words, when a switch is made between the amplification curves, there is no “popping” or the like, so that noiseless switching is made possible. For example during the switching between the amplification curves there may be a gradual adaptation between the amplification curves (fading), thus avoiding formation of artifacts. Comfort is thus further enhanced.

A user-specific maximum level is predefined that corresponds, for example, to the pain threshold or at least to a discomfort threshold of the user. The user-specific maximum level can be predefined, for example by the user, an audiologist, or a manufacturer of the hearing device. For example, the user-specific maximum level is different among all users, or is the same among some, many, or all users. A maximum level of the first signal component that is determined for the present situation results in the user-specific maximum level. In other words, by use of the first amplification curve, the portion of the first signal component that has the maximum level for the present situation is adapted in such a way that the associated portion of the first processed signal has the user-specific maximum level. The maximum level for the present situation is continuously determined, for example, and corresponds in particular to the maximum of the first signal component in the present situation up to the present point in time, or for example corresponds to the average value over a certain time period. The first amplification curve advantageously extends linearly between the user-specific maximum level and the possibly present level associated with the background noise of the present situation.

By use of the second amplification curve, a maximum level of the second signal component that is determined for the present situation results in the user-specific maximum level. In other words, those portions of the second signal component that have the maximum level that is determined for the present situation have the user-specific maximum level after the amplification. The maximum level is thus associated with the two signal components by use of the amplification curves; however, the maximum levels determined for the present situation may differ between the two signal components. The two amplification curves between the level associated with the background noise of the present situation and the user-specific maximum level can be essentially linear, with the two amplification curves in particular having different slopes. Processing is thus facilitated, and the speech of the other person is comparatively well understandable by the user. In addition, the second amplification factor is thus selected based on the difference between the level of the first processed signal and the level of the second processed signal, namely, by appropriately selecting the amplification curves. However, it is not necessary to implicitly determine the difference.

For example, the second signal component corresponds only to speech of a single person. For example, if multiple persons are present, a particular second amplification factor is selected for each of them. However, the second signal component can correspond to speech of multiple persons, advantageously to the speech of all persons that are present in the possibly existing present situation. Thus, those components in the input signal that arise from the speech of other persons are associated with the second signal component. Processing is thus simplified.

The hearing device can be, for example, a headset or particularly preferably a hearing aid. For example, the hearing aid is a “receiver in the canal” (RIC) hearing aid, an ear-internal hearing aid such as an “in the ear” hearing aid, an “in the canal” (ITC) hearing aid, or a “completely in canal” (CIC) hearing aid, hearing aid glasses, or a pocket hearing aid. The hearing aid can be a “behind the ear” hearing aid that is worn behind the outer ear.

The hearing device can include a microphone. The microphone has an omnidirectional design, for example, or it is suitably possible to change a directional characteristic of the microphone. The microphone can have two or more microphone units for this purpose. The microphone is suitable, in particular provided and configured, for detecting ambient sound. An input signal is advantageously generated by means of the microphone when the ambient sound is detected. The hearing device also includes a signal processing unit that can be connected to the microphone via signaling. In particular, the input signal is supplied to the signal processing unit during operation.

The hearing device can be operated according to a method in which the input signal is generated based on the ambient sound. A first signal component and a second signal component are extracted from the input signal, the first signal component corresponding to speech of a user, and the second signal component corresponding to speech of another person. A first processed signal is generated based on the first signal component and a first amplification factor, and a second processed signal is generated based on the second signal component and a second amplification factor. The two processed signals are combined to form an output signal. The first amplification factor is selected based on a difference between the level of the first signal component and the level of the second signal component. The signal processing unit is advantageously suited, in particular provided and configured, for at least partially carrying out the method.

The refinements and advantages explained in conjunction with the method are analogously transferable to the hearing device and between one another, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a simplified illustration of a hearing device,

FIG. 2 shows a method for operating the hearing device,

FIG. 3 schematically shows a type of processing of a first signal component and a second signal component when the method is being carried out, and

FIGS. 4 and 5 show amplification curves that are used for an example type of processing.

### DETAILED DESCRIPTION

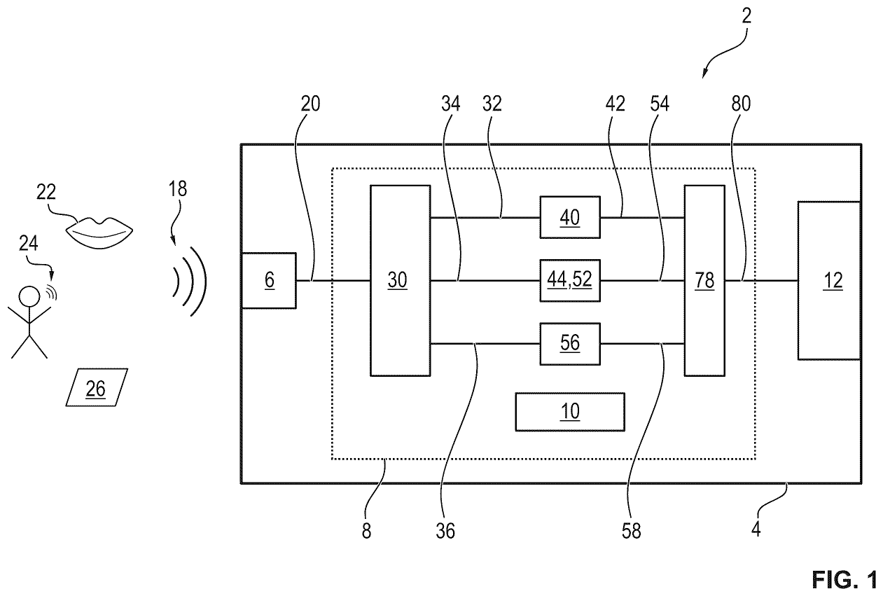

FIG. 1 includes a hearing device 2 that is illustrated in a schematically simplified manner. The hearing device 2 has a housing 4, inside of which a microphone 6 is situated. The microphone 6 includes multiple microphone units, not illustrated in greater detail, which are each designed as an electromechanical acoustic transducer or a capacitive acoustic transducer. A signal processing unit 8 having a control unit 10 is connected downstream from the microphone 6 via signaling. Connected downstream from the signal processing unit 8 via signaling is an earphone 12 which, when used as intended by a user, allows sound to be output into an auditory canal of the user, not illustrated in greater detail.

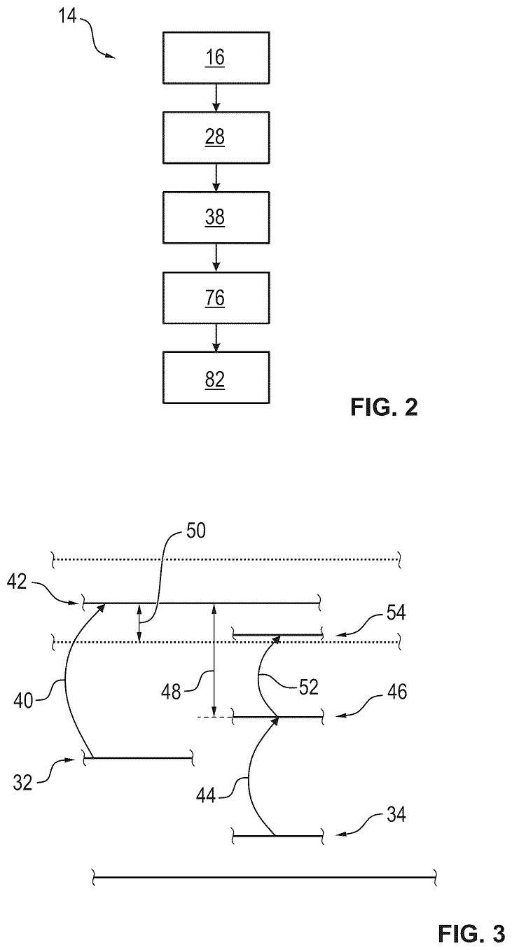

FIG. 2 illustrates a method 14 for operating the hearing device 2, which is carried out, at least in part, by use of the signal processing unit 8. An input signal 20 is generated based on an ambient sound 18 in a first work step 16. For this purpose, the ambient sound 18 impinging on the microphone 6 from outside the housing 4 is detected by means of the microphone 6 and is converted into the electrical input signal 20, which is led to the signal processing unit 8. The ambient sound 18 is made up of three components, one of the components representing the speech 22 of the user him/herself. A further component of the ambient sound 18 is present due to a conversation partner, and is thus speech 24 of another person. The third component arises from other sources of sound 26.

In a subsequent second work step 32, a splitting unit 30 of the signal processing unit 10 extracts a first signal component 32 and a second signal component 34 from the input signal 20. The remainder of the input signal 20 is associated with a third signal component 36. The first signal component 32 corresponds to the speech 22 of the user, and the second signal component 34 corresponds to the speech 24 of the other person. If multiple persons are speaking, this speech is likewise associated with the second signal component 34. In other words, the second signal component 34 corresponds to speech 24 of multiple persons. For the splitting, a spatial analysis, for example, is used to check where the individual components of the ambient sound 18 originate. The directional characteristic of the microphone 6 is set/checked for this purpose.

The first signal component 32 is processed in a subsequent third work step 38 by use of a first amplification factor 40, so that a first processed signal 42 is generated. For this purpose, in particular the first signal component 32 is multiplied by the first amplification factor 40. The first amplification factor 40 is predefined, and is selected as a function of the hearing loss of the user. Based on the processing using the first amplification factor 40, the level of the first signal component 32 is raised so that the level of the first processed signal 42 has an elevated level, as schematically shown in FIG. 3.

In addition, the second signal component 34 is initially multiplied by a second preliminary amplification factor 44, so that a second preliminary processed signal 46 is generated. The second preliminary amplification factor 44 is equal to the first amplification factor 40, so that initially amplification takes place as a function of the hearing loss of the user. Based on the processing, the level of the second preliminary processed signal 46 is likewise increased, as illustrated in FIG. 3. The level of the first processed signal 42 subsequently has a difference 48 from the level of the second preliminary processed signal 46. In the illustrated example, the difference 48 is greater than a limit value 50, in the illustrated example the level of the second preliminary processed signal 46 being lower than the level of the first processed signal 42.

The second preliminary processed signal 46 is subsequently multiplied by a second amplification factor 52, so that a second processed signal 54 is generated. The second amplification factor 52 is selected in such a way that the level of the second processed signal 54 differs from the level of the first processed signal 42 by exactly the limit value 50, the level of the second processed signal 54 being lower than the level of the first processed signal 42. If the level of the second preliminary processed signal 46 differs from the level of the first processed signal 42 by less than the limit value 50, “1” is used as the second amplification factor 52. The second preliminary processed signal 46 thus corresponds to the second processed signal 54.

In summary, the first amplification factor 40 is predefined, and the second amplification factor 52 is selected in such a way that the level of the first processed signal 42 differs from the level of the second processed signal 54 by less than the limit value 50. In addition, the second amplification factor 52 is selected as a function of the difference 48 between the level of the first processed signal 42 and the level of the second processed signal 54, namely, in such a way that the difference 48 is less than the limit value 50. For this purpose, based on the second signal component 34 and the second preliminary amplification factor 44 the second preliminary processed signal 46 is initially generated, and its level is compared to the level of the first processed signal 42. Based on the comparison, the second amplification factor 52 is then selected. If the level of the second preliminary processed signal 46 is higher than the level of the first processed signal 42, and the difference 48 is greater than the limit value 50, the second amplification factor 52 is selected in such a way that the level of the two processed signals 42, 54 differs by less than the limit value 50, but with the level of the second processed signal 54 being higher than the level of the first processed signal 42.

The third signal component 36 is processed using a third amplification factor 56, so that a third processed signal 58 is generated. The third amplification factor 56 is predefined as a function of the hearing loss of the user, and of the present situation.

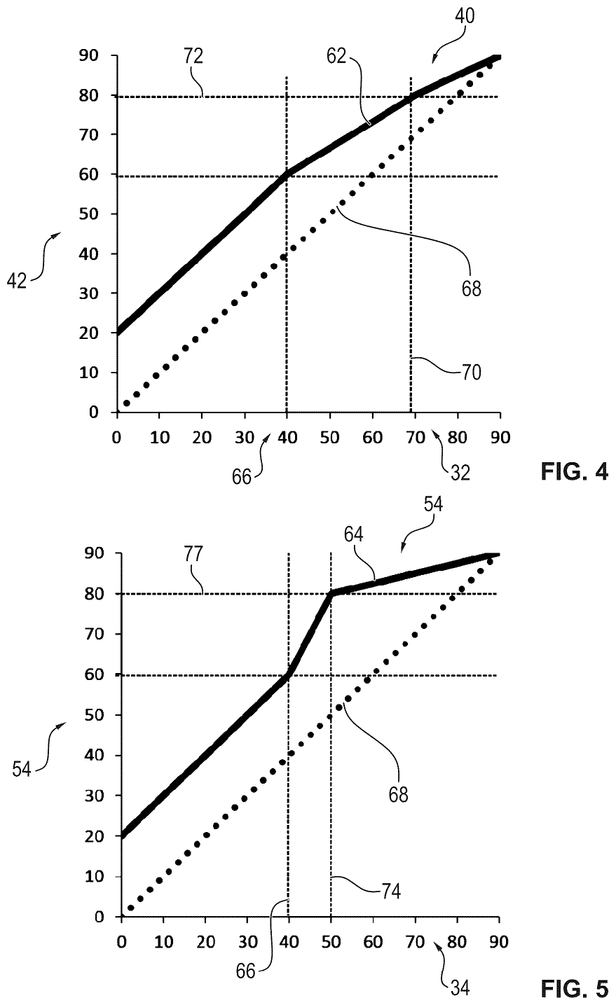

Also, automatic gain control can be used instead of direct multiplication by the amplification factors 40, 44, 52. A first amplification curve 62, illustrated in FIG. 4, is associated with the first signal component 32, and a second amplification curve 64, illustrated in FIG. 5, is associated with the second signal component 34. The first amplification factor 40 and the second amplification factor 52 are at least implicitly predefined by means of the two amplification curves 62, 64. The first amplification curve 62 indicates which level is to be used for the first processed signal 42 for a particular level of the first signal component 32. Likewise, the second amplification curve 64 indicates on which level of the particular levels of the second signal component 34 mapping is to be performed in order to obtain the second processed signal 54.

The two amplification curves 62, 64 are designed and adapted to the particular present situation in such a way that the amplification curves are the same at the level of background noise 66 of the particular present situation. The background noise 66 results from background noise of the present situation in which the user is present. Thus, in the illustrated example, the unit value 60 is associated in each case with the unit value 40 of the level of both the first signal component 32 and the second signal component 34 as the level of the first processed signal 42 or of the second processed signal 54, respectively. Below the level of the background noise 66, the two amplification curves 62, 64 are the same and have a linear design. At that location the two amplification curves 62, 64 have a slope of “1” and are shifted in parallel to the identity 68 (identical mapping), illustrated by a dotted line. In summary, the two amplification curves 62, 64 are selected in such a way that they are the same at the level associated with the background noise 66 of the present situation. Thus, if neither the user nor other persons are speaking, or the level of the particular speech 22, 24 is lower than the level of the background noise 66, it is irrelevant which of the two amplification curves 62, 64 is selected, and the first processed signal 42 then corresponds to the second processed signal 54.

In addition, a maximum level 70 of the first signal component 32 for the present situation is determined, which in the illustrated example just reaches the value 70. For determining the maximum level 70 of the first signal component 32, the particular present level of the first signal component 32 is detected for a certain time period, such as 10 seconds, and the maximum thereof is used as the maximum level 70 of the first signal component 32 for the present situation. A user-specific maximum level 72, which in the illustrated example has the value of 80, is associated with this maximum level 70 of the first signal component 32 The user-specific maximum level 72 is predefined by the manufacturer of the hearing device 2 or is adapted to the user, for example by an audiologist. The user-specific maximum level 72 represents the discomfort threshold for the user. Thus, the user-specific maximum level 20 is associated with those portions of the first signal component 32 that have the maximum level 70 of the first signal component 32 for the present situation. Two points are thus predefined for the first amplification curve 62, namely, the level of the background noise 66 with which the value of 60 is associated, and the maximum level 70 of the first signal component 32, with which the user-specific maximum level 72 is associated. The course of the first amplification curve 62 is linear between these two points. At higher levels the course of the first amplification curves 62 is likewise linear, but with a decreased slope.

A maximum level 74 for the present situation is also determined for the second signal component 34. This takes place in the same way as for the determination of the maximum level 70 of the first signal component 32. In the illustrated example, the maximum level 74 of the second signal component 34 has the value of 50. The user-specific maximum level 72, i.e., the value of 80, is also associated with this maximum level. The second amplification curve 64 has a linear course between the two points that are defined by the background noise 66 and the maximum level 74 of the second signal component 34. However, since the maximum level 70 of the first signal component 32 is higher than the maximum level 74 of the second signal component 34, the slope of the second amplification curve 64 is increased. Above the maximum level 74 of the second signal component 34, the course of the second amplification curve 64 is once again linear, namely, up to the values that are predefined by the maxima of 90, which is also the case for the first amplification curve 62.

In summary, the two amplification curves 62, 64 are selected in such a way that the maximum level 70 of the first signal component 32, determined for the present situation, results in the user-specific maximum level 72. In addition, the maximum level 74 of the second signal component 34, determined for the present situation, results in the user-specific maximum level 74.

Regardless of the particular embodiment, in the third work step 38 the first processed signal 42 is generated based on the first signal component 32 and the first amplification factor 40, and the second processed signal 54 is generated based on the second signal component 34 and the second amplification factor 52.

By use of an adder 78 of the signal processing unit 10, the third processed signal 58, the second processed signal 54, and the first processed signal 42 are added in a subsequent fourth work step 76 to form an output signal 80, which is output by the adder 65. The first and second processed signals 42, 54 are thus combined to form the output signal 80.

The output signal 80 is output by means of the earphone 12 and thus provided to the user in a subsequent fifth work step 82. When the user has comparatively poor understanding of the speech 24 of the other persons, he/she unconsciously speaks more loudly, as described by the Lombard effect. This results in stronger amplification of the second signal component 34, so that the second processed signal 54 has an increased level. Depending on the embodiment, this has already taken place during slightly louder speech 24 of the other person, or even if the other person does not speak more loudly. Understandability is thus increased for the user.

The invention is not limited to the exemplary embodiments described above. Rather, other variants of the invention may also be derived by those skilled in the art without departing from the subject matter of the invention. In particular, all individual features described in conjunction with the individual exemplary embodiments may also be combined with one another in some other way without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a hearing device, the method comprising:
generating an input signal based on an ambient sound;
extracting a first signal component and a second signal component from the input signal, the first signal component corresponding to speech of a user, the second signal component corresponding to speech of another person;
generating a first processed signal based on the first signal component and a first amplification factor;
generating a second processed signal based on the second signal component and a second amplification factor;
combining the first and second processed signals to form an output signal; and
selecting the second amplification factor as a function of a difference between the level of the first processed signal and the level of the second processed signal.

2. The method according to claim 1, wherein the first amplification factor is predefined, and the second amplification factor is selected such that the level of the first processed signal differs from the level of the second processed signal by less than a limit value.

3. The method according to claim 1, wherein based on the second signal component and a second preliminary amplification factor, a second preliminary processed signal is generated, whose level is compared to the level of the first processed signal, wherein the second amplification factor is selected based on the comparison, and wherein the second processed signal is generated based on the second preliminary processed signal (and the second amplification factor.

4. The method according to claim 1, wherein automatic gain control is used, wherein a first amplification curve is associated with the first signal component, and wherein a second amplification curve is associated with the second signal component.

5. The method according to claim 4, wherein the first and second amplification curves are the same for the level associated with background noise of the present situation.

6. The method according to claim 4, wherein the first and second amplification curves are selected such that a maximum level of the first signal component determined for the present situation results in a user-specific maximum level, and wherein a maximum level of the second signal component determined for a present situation results in a user-specific maximum level (72).

7. The method according to claim 1, wherein the second signal component corresponds to speech of at least two persons.

8. A hearing device comprising:
a microphone to detect an ambient sound; and
a signal processing unit that is operated according to the method according to claim 1.
